(19) United States
(12) Patent Application Publication
(10) Pub. No.: US 2007/0061337 A1
(43) Pub. Date: Mar. 15, 2007

(54) Electronic paper system, control apparatus and method for electronic paper system, storage medium storing control program

(75) Inventors: Yasunori Saito, Kanagawa (JP); Tsunemasa Mita, Kanagawa (JP); Tsutomu Ishii, Kanagawa (JP); Ikutaroh Nagatsuka, Kanagawa (JP); Minoru Koshimizu, Kanagawa (JP)

Correspondence Address: OLIFF & BERRIDGE, PLC, P.O. BOX 19928, ALEXANDRIA, VA, 22320, US

(73) Assignee: Fuji Xerox Co., Ltd., Tokyo (JP)

(21) Appl. No.: 11/364,077

(22) Filed: Mar. 1, 2006

(30) Foreign Application Priority Data
Sep. 13, 2005 (JP) 2005-265498

(51) Int. Cl. G06F 17/30

(52) U.S. Cl. 707/10

(57) ABSTRACT

An electronic paper system includes: a document data storage which stores document data; an electronic paper having a display that displays and retains a document image based on the document data in a no-power state and a memory that readably and writably stores link information enabling access to the document data stored in the document data storage; and a control apparatus which, when storing the document data in the document data storage, controls a method of storing the document data in the document data storage in accordance with a preset condition, and controls the storage of the link information in the memory of the electronic paper in response to the method thus controlled.

### BACKGROUND OF THE INVENTION

(i) Field of the Invention

The present invention relates to a technology using a thin electronic paper which displays and retains an image in a no-power state on a display, and readably and writably stores information in a memory, and more particularly to a technology which, when storing link information such as a URL enabling access to document data in the electronic paper, carries out control of correlation between an image relating to the document retained on the electronic paper and the document data.

(ii) Description of the Related Art

Compilation, editing, perusal etc. of a document involving electronic data pertaining to various media such as an image and a text are being performed using a computer.

A perusal method of this kind of electronic data document is generally implemented in such a way that an image of a document is displayed on a computer display screen or an image of a document is printed onto a paper medium by means of a printer.

A thin electronic paper with the flexibility of paper, which displays and retains an image in a no-power state, has recently been developed as a medium for document perusal which can replace paper.

The electronic paper is a device having a display which displays and retains an image in a no-power state. Roughly classified according to a writing format of an image onto the display, there are a self-writing type of electronic paper, which has a function of writing an image onto the display by itself according to electronic data, and a transfer writing type of electronic paper, which retains on the display an image which is written by means of projection transfer, thermo transfer or the like.

In contrast to paper, this kind of electronic paper can delete and overwrite an image displayed and retained on the display allowing it to be reused, making the promotion of its use desirable from the point of view of saving paper resources.

Also, as the electronic paper is provided with a memory which retains information in such a way that it can be read and written from the exterior, as per, for example, an RFID, information (electronic data) relating to an image displayed and retained on the display can be retained.

As one mode of application of an electronic paper, a system is being considered wherein, by storing a URL of document data stored in a data base or the like in an RFID of the electronic paper, displaying and retaining an image (thumbnail etc.) of the document data on the display of the electronic paper, and correlating the electronic paper and document data, corresponding document data stored in the data base or the like can be accessed using electronic paper in which a document image is stored and retained.

A variety of operations, such as storage in the data base and removal (deletion) from the data base, are carried out on a daily basis with respect to document data, meaning that in the event that the aforementioned kind of system is actualized, it is necessary to control an image and information retained by the electronic paper according to an operation with respect to document data, and, there has been a demand to actualize this kind of control processing.

### SUMMARY OF THE INVENTION

This invention has been made in view of the aforementioned existing circumstances.

This invention provides, as an illustrative, non-limiting embodiment, an electronic paper system including: a document data storage which stores document data; an electronic paper having a display that displays and retains a document image based on the document data in a no-power state and a memory that readably and writably stores link information enabling access to the document data stored in the document data storage; and a control apparatus which, when storing the document data in the document data storage, controls a method of storing the document data in the document data storage in accordance with a preset condition, and controls the storage of the link information in the memory of the electronic paper in response to the method thus controlled.

This invention provides, as an illustrative, non-limiting embodiment, an electronic paper system including: a document data storage which stores document data; an electronic paper having a display that displays and retains a document image based on the document data in a no-power state and a memory that readably and writably stores link information enabling access to the document data stored in the document data storage; and a control apparatus which, in response to access to the document data storage, controls the display of the electronic paper to change the document image of the document data in accordance with a preset condition.

This invention provides, as an illustrative, non-limiting embodiment, a control apparatus for an electronic paper system including a document data storage which stores document data, and an electronic paper having a display that displays and retains a document image based on the document data in a no-power state and a memory that readably and writably stores link information enabling access to the document data stored in the document data storage. The control apparatus includes: means for controlling a method of storing the document data in the document data storage in accordance with a present condition when the document data is stored in the document data storage; and means for controlling the storage of the link information in the memory of the electronic paper in response to the method thus controlled.

This invention provides, as an illustrative, non-limiting embodiment, a control apparatus for an electronic paper system including a document data storage which stores document data, and an electronic paper having a display that displays and retains a document image based on the document data in a no-power state and a memory that readably and writably stores link information enabling access to the document data stored in the document data storage. The control apparatus includes: means for obtaining a preset condition; and means, in response to access to the document data storage, for controlling the display of the electronic paper to change the document image of the document data in accordance with the present condition.

This invention provides, as an illustrative, non-limiting embodiment, a storage medium readable by a computer, the storage medium storing a program of instructions executable by the computer to perform a function for controlling an electronic paper system including a document data storage which stores document data, and an electronic paper having a display that displays and retains a document image based on the document data in a no-power state and a memory that readably and writably stores link information enabling access to the document data stored in the document data storage. The function includes the steps of controlling a method of storing the document data in the document data storage in accordance with a present condition when the document data is stored in the document data storage; and controlling the storage of the link information in the memory of the electronic paper in response to the method thus controlled.

This invention provides, as an illustrative, non-limiting embodiment, a storage medium readable by a computer, the storage medium storing a program of instructions executable by the computer to perform a function for controlling an electronic paper system including a document data storage which stores document data, and an electronic paper having a display that displays and retains a document image based on the document data in a no-power state and a memory that readably and writably stores link information enabling access to the document data stored in the document data storage. The function includes the steps of obtaining a preset condition; and controlling the display of the electronic paper to change the document image of the document data in accordance with the present condition, in response to access to the document data storage.

This invention provides, as an illustrative, non-limiting embodiment, a control method for an electronic paper system including: a document data storage which stores document data; an electronic paper having a display that displays and retains a document image based on the document data in a no-power state and a memory that readably and writably stores link information enabling access to the document data stored in the document data storage; and a control apparatus. The control method includes the steps of controlling, with the control apparatus, a method of storing the document data in the document data storage in accordance with a present condition when the document data is stored in the document data storage; and controlling, with the control apparatus, the storage of the link information in the memory of the electronic paper in response to the method thus controlled.

This invention provides, as an illustrative, non-limiting embodiment a control method for an electronic paper system including: a document data storage which stores document data; an electronic paper having a display that displays and retains a document image based on the document data in a no-power state and a memory that readably and writably stores link information enabling access to the document data stored in the document data storage; and a control apparatus. The control method includes the step of: obtaining a preset condition with the control apparatus; and controlling, with the control apparatus, the display of the electronic paper to change the document image of the document data in accordance with the present condition, in response to access to the document data storage.

Accordingly, one of advantages is as follows: In a system using an electronic paper which is correlated with document data by link information such as a URL, and which displays and retains an image relating to the document, the image and information retained by the electronic paper can be controlled in response to an operation with respect to the document data. Consequently, document management and operation using the electronic paper can be made easier for the user to carry out.

### BRIEF DESCRIPTION OF THE DRAWINGS

Preferred embodiment(s) of the present invention will be described in detail based on the following figures, wherein:

FIG. 1 is a configuration diagram of an electronic paper system according to one embodiment of the invention;

FIG. 2 is a configuration diagram of an electronic paper system according to another embodiment of the invention;

FIG. 3 is a configuration diagram of an electronic paper system according to still another embodiment of the invention;

FIG. 4 is a diagram showing one example of a functional configuration of an information processing apparatus and an electronic paper printer according to the invention;

FIG. 5 is a diagram showing one example of a functional configuration of a control server according to the invention;

FIG. 6 is a diagram illustrating link connection according to one example of the invention;

FIG. 7 is a diagram illustrating data import (storage) processing according to one example of the invention;

FIG. 8 is a diagram illustrating data deletion processing according to one example of the invention;

FIG. 9 is a view illustrating an example of a display image according to the invention;

FIG. 10 is a view illustrating an example of the display image according to the invention;

FIG. 11 is a view illustrating an example of the display image according to the invention;

FIG. 12 is a view illustrating an example of the display image according to the invention;

FIG. 13 is a view illustrating an example of the display image according to the invention;

FIG. 14 is a view illustrating an example of the display image according to the invention;

FIG. 15 is a view illustrating an example of the display image according to the invention;

FIG. 16 is a view illustrating an example of the display image according to the invention;

FIG. 17 is a view illustrating an example of the display image according to the invention;

FIG. 18 is a view illustrating an example of the display image according to the invention;

FIG. 19 is a view illustrating an example of the display image according to the invention;

FIGS. 20(a) and 20(b) are views showing one example of an external writing type electronic paper;

FIG. 21 is a view illustrating a method of use of the external writing type electronic paper;

FIG. 22 is a diagram illustrating an operating principle of the external writing type electronic paper;

FIG. 23 is a view illustrating a configuration of the external writing type electronic paper;

FIGS. 24(a) and 24(b) are views showing one example of a self-writing type electronic paper;

FIG. 25 is a diagram illustrating an operating principle of the self-writing type electronic paper; and

FIG. 26 is a diagram illustrating a configuration of the self-writing type electronic paper.

### DETAILED DESCRIPTION OF THE INVENTION

A detailed description of the invention will be made based on an embodiment thereof.

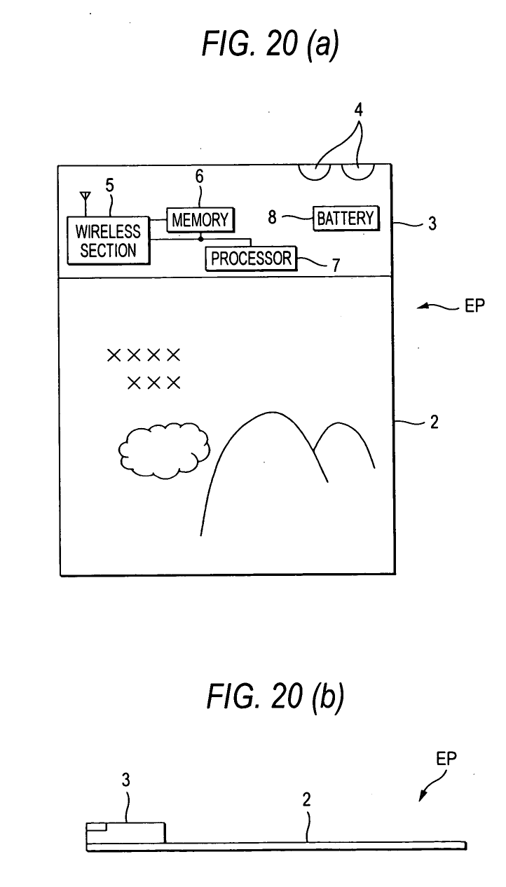

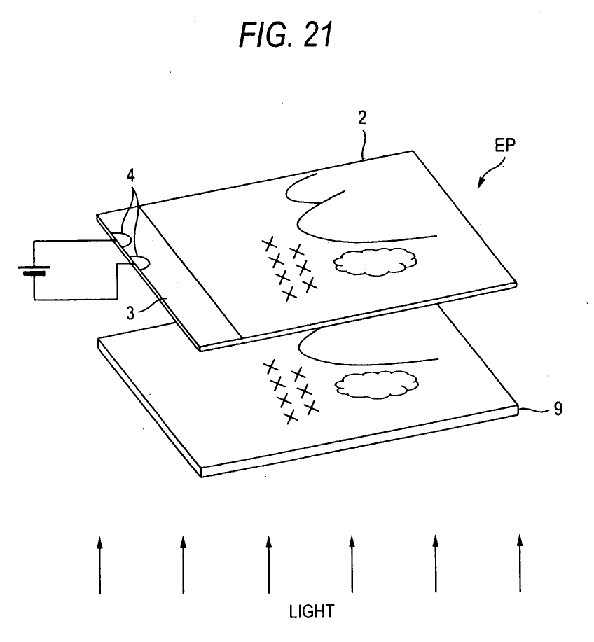

First, a specific description will be made, with reference to FIGS. 20 to 26, of electronic paper which can be used with the invention.

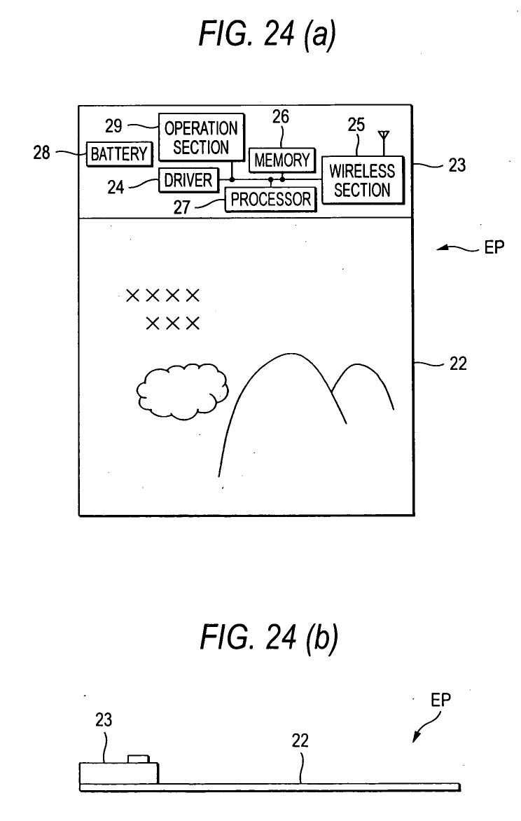

Electronic paper EP has as the method of recording an image to be displayed and retained, for example, an external writing type, as shown in FIGS. 20 to 23, and a self-rewriting type, as shown in FIGS. 24 to 26. According to either format, the electronic paper EP is an information recording/retaining device with a paper-like thinness entitling it to be referred to as an electronic paper.

FIG. 20(a) is a front view showing an optical writing type electronic paper EP as one example of the external writing type, while FIG. 20(b) is a side view of the optical writing type electronic paper. The electronic paper EP shown includes a display 2 which displays and retains an image in a no-power state, and a processor 3 which conducts processing of electronic data such as document data URL. FIG. 20(a) also shows functional sections built into the processor 3.

The optical writing type electronic paper EP is a flexible, thin form having, for example, a size such as that of a card or A4 paper regulated by JIS standards, wherein the processor 3 is provided at one end of the display 2 which occupies the greater portion of the area. The size of the display 2 is optional, being arranged in accordance with the application when used as a tag or card as described hereafter.

The processor 3 includes a writing electrode 4 for applying the voltage to drive the display 2 as described hereafter, a wireless portion 5 for wireless communication with the exterior, a memory 6 which writably retains electronic data, a processor 7 which conducts processing such as an access to the memory 6, a battery 8 which supplies driving electric power to the processor 7 and wireless portion 5, and the like.

The optical writing type electronic paper EP can transmit and receive electronic data by means of wireless communication between an external wireless device (an electronic paper printer in an example to be described hereafter) and the wireless portion 5, and can retain these electronic data in the memory 6.

The example in the figure shows the processor 3 having a comparatively high level data processing function, but it is also possible to use as the processor 3 a heretofore known RFID which has a comparatively simple configuration comprising a wireless data communicating function and a data memory function.

In the optical writing type electronic paper EP, for example, as shown in FIG. 21, an image to be written is displayed on a liquid crystal panel 9, the optical writing type electronic paper EP is positioned over the liquid crystal panel 9, and by irradiating them with a light while applying a voltage to the electrode 4 from an external power source, the image displayed on the liquid crystal panel 9 can be transferred to the display 2 and stored in the memory. To summarize, the optical writing type electronic paper EP possesses a function whereby it transfers a projected image to the display 2 by means of applying a voltage to the electrode 4, and the transferred image is retained in a displayed condition even after the voltage applied to the electrode 4 is removed (in no-power state).

When using this kind of optical writing type electronic paper EP, the electronic paper printer to be described hereafter is equipped with means necessary for optical writing which comprises a portion for applying a voltage to the electrode 4, the liquid crystal panel 9 and a light irradiation portion. The kind of printer mentioned in JP-A-2004-106495 can be used as one example of the electronic paper printer.

As shown in FIG. 23, which shows the cross section structure of the display 2, the optical writing type electronic paper EP has the structure in which a layer of organic optical electrically conductive material (organic optical electrically conductive layer) 10 used in a reproduction instrument is combined with a layer of liquid crystal display material (microencapsulated cholesteric liquid crystal layer) 11, the layers being sandwiched by a front-back pair of transparent electrodes 12, and the laminated body being sandwiched by a front-back pair of transparent material film 13. This configuration enables a monochromatic image display comprising a white display of light reflected by the cholesteric liquid crystal layer 11, and a black display of light permeating the liquid crystal layer 12 and absorbed by a black layer 14 provided between the cholesteric liquid crystal layer 11 and the organic light conducting layer 10. Furthermore, as the cholesteric liquid crystal has a characteristic of interference reflection of colour light corresponding to a spiral pitch, it is also possible to actualize a colour display with a simple structure by configuring the cholesteric liquid crystal layer 11 in such a way as to comprise layers of liquid crystal of differing spiral pitch.

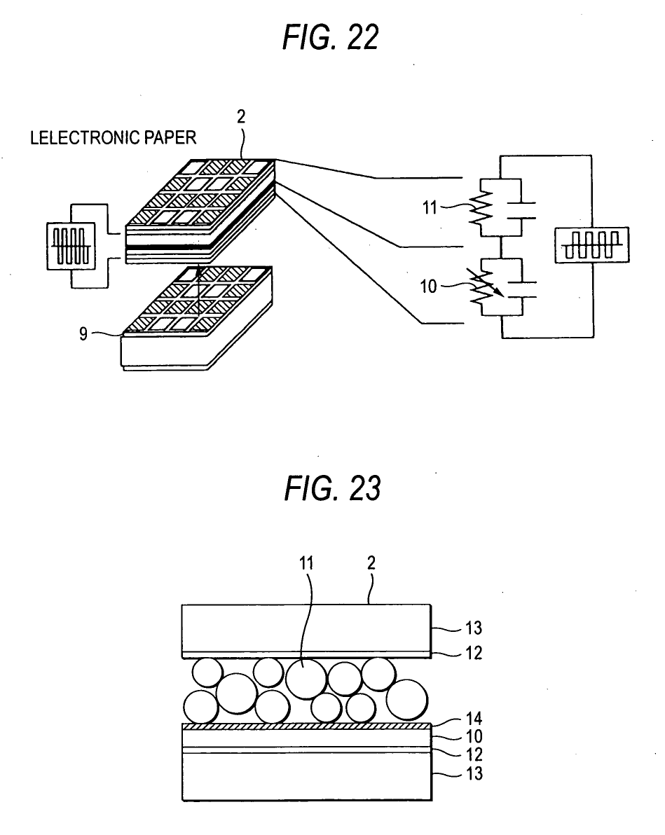

In the optical writing type electronic paper EP, as shown in FIG. 22 showing the display 2 operating principle, for example, the transferred image is displayed on an image writing dimmer panel (light emitting panel) 9 and projected on the display 2, and when a voltage is thus applied to electrode 4, high and low light intensities are instantaneously converted to reflection density to retain the projected image. Also, by applying a deletion voltage to the electrode 4, the image information retained on the display 2 can be deleted, so that by repeating the writing and deletion process, the optical writing type electronic paper EP can be reused any number of times.

Furthermore, in the optical writing type electronic paper EP, instead of carrying out this kind of deletion process, the image information retained on the display 2 can also be overwritten by projecting a new image with a voltage applied to the electrode 4 as described previously. Thus, the optical writing type electronic paper EP can also be reused any number of times by means of such an overwriting process.

As another example of the external writing type electronic paper, there is one wherein the display 2 is made to have a thermosensitive recording structure as heretofore known, an image is thermally recorded on the display 2 by means of a thermal recording head installed on a printer, and displayed and retained thereon.

A system of an embodiment to be described hereafter uses a card type electronic paper EP which, having this kind of thermosensitive recording type electronic paper configured as a JIS standard card size, is equipped with an RFID as the processor 3.

FIG. 24(a) is a front view showing a self-writing type electronic paper EP, while the same FIG. 24(b) is a side view of the self-writing type electronic paper EP. The electronic paper EP shown includes a display 22, which displays and retains an image, and a processor 23 which conducts processing of electronic data. FIG. 24(a) also shows functional sections built into the processor 23.

The self- writing type electronic paper EP is a flexible, thin form recording device having, for example, a size such as that of a card regulated by JIS standards, as described previously, wherein the processor 23 is provided at one end of the display 22 which occupies the greater portion of the area. The size of the display 22 is arranged in accordance with the application. Also, the electronic paper EP may be configured such that the display 22 and the processor 23 are made attachable and removable from each other, and such that the processor 23 of clip format for example is attached and connected to the display 22.

The processor 23 is provided with a driver 24 for driving the display 22, a wireless portion 25 for wireless communication with an exterior such as the electronic paper printer, a memory 26 which writably retains electronic data, a processor 27 which conducts processing of electronic data, and a battery 28 which supplies driving electric power to functional means such as the processor 27.

This kind of self-writing type electronic paper EP transmits and receives electronic data by means of wireless communication between an external wireless device (such as the electronic paper printer) and the wireless portion 25, and can thereby retain these electronic data in the memory 26.

The self-writing type electronic paper EP possesses a function whereby the driver 24 is driven under the control of the processor 27, an image to be displayed and retained on the display 22 can be rewritten and displayed in accordance with the electronic data retained in the memory 26, and the image is retained in a displayed condition even after the driver 24 driving electric power is removed.

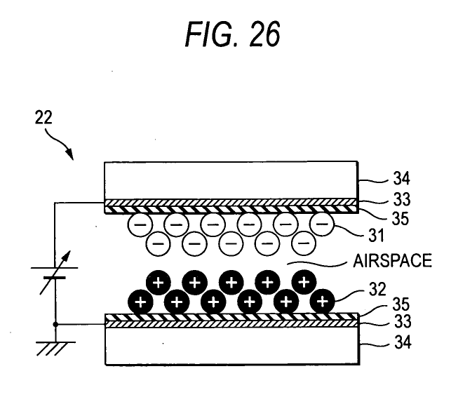

As shown in FIG. 26 showing the cross section structure of the display 2, the structure of the self-writing type electronic paper EP is such that minute colouring particles (white particles 31 and black particles 32 in the example shown in the figure) used as toner in a reproduction instrument are enclosed in a front-back pair of electrodes 33 of which at least the surface is transparent, this assembly being sandwiched between a front-back pair of film substrates 34 of which at least the surface is transparent. An air layer is provided between the electrode layers 33 in order that the colouring particles 31 and 32 can move freely, and an insulation layer 35 is attached to the matrix-shaped electrode layer 33 to prevent its contact with the colouring particles 31 and 32. It is also possible to actualize a colour display with a simple configuration by using a colour filter.

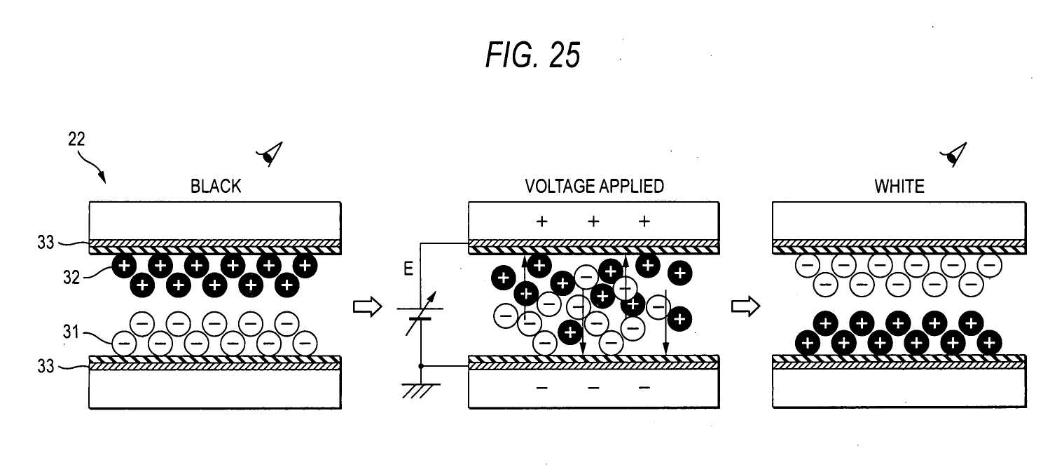

In the self-writing type electronic paper EP, as shown in FIG. 25 showing the display 22 operating principle, with no voltage being applied to the electrode 33 (although the electrode 33 is charged with the polarity of the previous drive), the negatively charged white particles 31 remain on the reverse side while the positively charged black particles 32 remain on the front side, so that the display 22 appears black when viewed from the front side. Also, by the driver 24 operating in accordance with the electronic data and inverting the electrode polarity of a predetermined portion of the matrix which corresponds to the image displayed, the relative positions of the white particles 31 and the black particles 32 are switched, and an image according to the contrast between the white particles 31 and the black particles 32 is displayed on the display 22. Furthermore, by operating the driver 24 in accordance with differing electronic data, the image information displayed on the display 22 can be changed according to the contrast between the white particles 31 and the black particles 32, so that the self-writing type electronic paper EP can be reused any number of times.

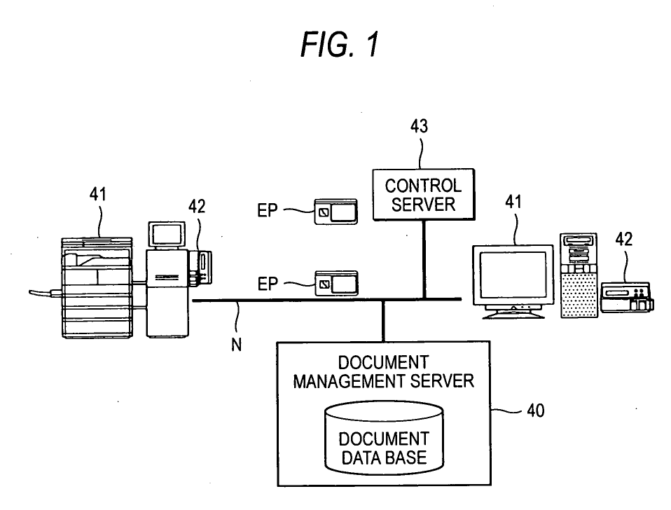

FIG. 1 shows an overall configuration example of an electronic paper system according to one example of the invention.

The system in the example has a configuration wherein a document management server (document storage) 40, an information processing apparatus 41 and a control server (control apparatus) 43 are connected by a network N, and an electronic paper printer 42 is appended to each information processing apparatus 41.

The document management server 40 includes a document data base which categorizes and stores document data by URL, and carries out storage management of document data received from the information processing apparatus 41 and the sending of requested document data to the information processing apparatus 41.

In the example shown in the figure, a multi-function machine (MF), including a combination of a scanner function, a reproduction function, a fax function and the like, and a personal computer (PC) are used as the information processing apparatus 41. The transfer writing of an image related to a document image and the writing or deleting of the URL (link information) needed to access the document data are carried out with respect to a transfer type electronic paper (card) EP having an RFID (processor) 3 by the electronic paper printer 42 connected to each information processing apparatus 41 as writing means.

Also, the process of writing information on and deleting information from the display 2 and RFID 3 is carried out under the control of the control server 43, as described hereafter.

The control server 43 carries out URL connection control, electronic paper card EP image change control and the like with respect to, for example, the storage processing of document data in the document management server 40 and deletion processing of document data from the document management server 40.

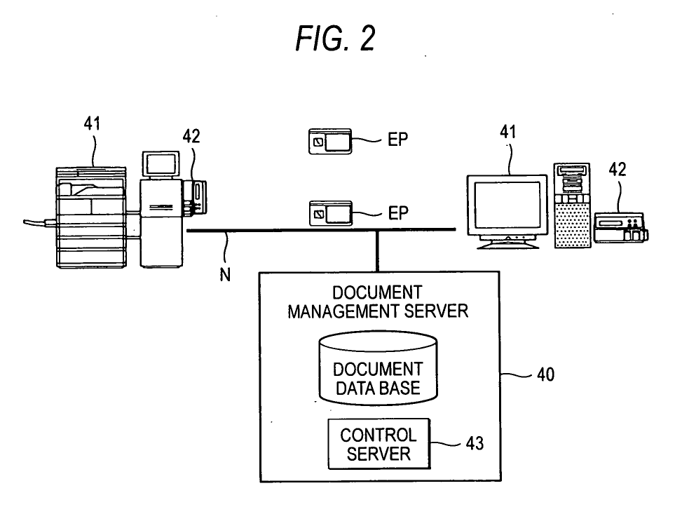

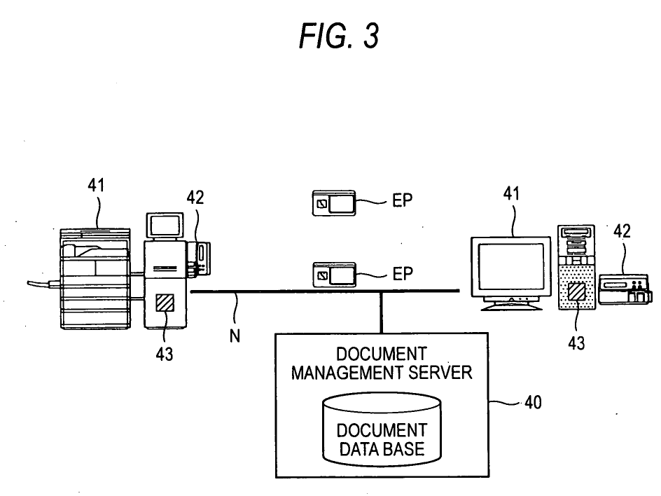

The control server 43 can be included in the electronic paper system by connecting to the network N as shown in FIG. 1, or can alternatively be included in the electronic paper system by integration with the document management server 40, as shown in FIG. 2, or by integration with each information processing apparatus 41, as shown in FIG. 3. It is sufficient that the control server 43 be included in such a way as to carry out the control processing necessary for the electronic paper system.

Before describing in detail the control processing of the control server 43, which is the feature of the invention, a description will be given of the storage processing and reading processing of document data using the electronic paper card EP, which are the basic processes of the electronic paper system.

Also, as the aforementioned processing is identical in all the systems shown in FIGS. 1 to 3, the processing example will be described with the system shown in FIG. 1 as a representative.

Firstly, in the storage processing, with the electronic paper card EP loaded in the electronic paper printer 42 of the multi-function machine (MF) 41, a document paper on which a document is printed is read by the scanner of the multi-function machine (MF) 41. The multi-function machine (MF) 41 stores the read document data, as well as attribute information such as the read date of the relevant document, in the document management server 40 via the network N. Furthermore, the control server 43 generates a contracted image (thumbnail image) of the document based on the read document data, writes and retains the thumbnail image on the display 2 of the electronic paper card EP by means of the electronic paper printer 42, at the same time sending the URL of the document data stored in the document management server 40 to the RFID of the electronic paper card, and storing the aforementioned data therein.

By this means, a thumbnail image which indicates an outline of the document data stored in the document management server 40 is displayed and retained on the electronic paper card EP discharged from the electronic paper printer 42, and a URL needed to access the relevant document data is stored and retained thereon.

Consequently, a user can easily search for a desired document by looking at a thumbnail image displayed and retained on an electronic paper card EP. For example, by loading an electronic paper card EP into the electronic printer 42 of the personal computer (PC) 41, acquiring a URL from the RFID of the electronic paper card EP by an electronic paper printer 42 RFID access method (so-called wireless reader writer), and accessing the document management server 40 via the PC 41 with the relevant URL, document data related to the electronic paper card EP (thumbnail image) can be read out, acquired and displayed on a screen.

Also, with an electronic paper card EP loaded in the electronic paper printer 42 of the PC 41, the electronic paper printer 42 is made to carry out the writing process related to document data stored in the PC 41 by, for example, dragging and dropping a document data icon displayed on the screen onto an electronic paper printer icon. As a result, the document data and document data attribute information are stored in the document management server 40 via the network N. Also, the control server 43 generates a contracted image (thumbnail image) of the document based on the document data, and writes and retains the thumbnail image on the display 2 of the electronic paper card EP by means of the electronic paper printer 42. At the same time, the control server 43 sends the URL of the document data stored in the document management server 40 to the RFID of the electronic paper card, and stores the aforementioned data therein.

By this means, as described heretofore, a thumbnail image which indicates an outline of the document data stored in the document management server 40 is displayed and retained on the electronic paper card EP discharged from the electronic paper printer 42, and a URL needed to access the relevant document data is stored and retained thereon.

Thus, document paper can be printed out, for example, by loading the electronic paper card EP into the electronic printer 42 of the MF 41, acquiring a URL from the RFID of the electronic paper card EP by the electronic paper printer 42 RFID access method or, in the case that the MF 41 is equipped with an RFDI access method, by that RFDI access method, and acquiring the document data pertaining to the URL via the MF 41.

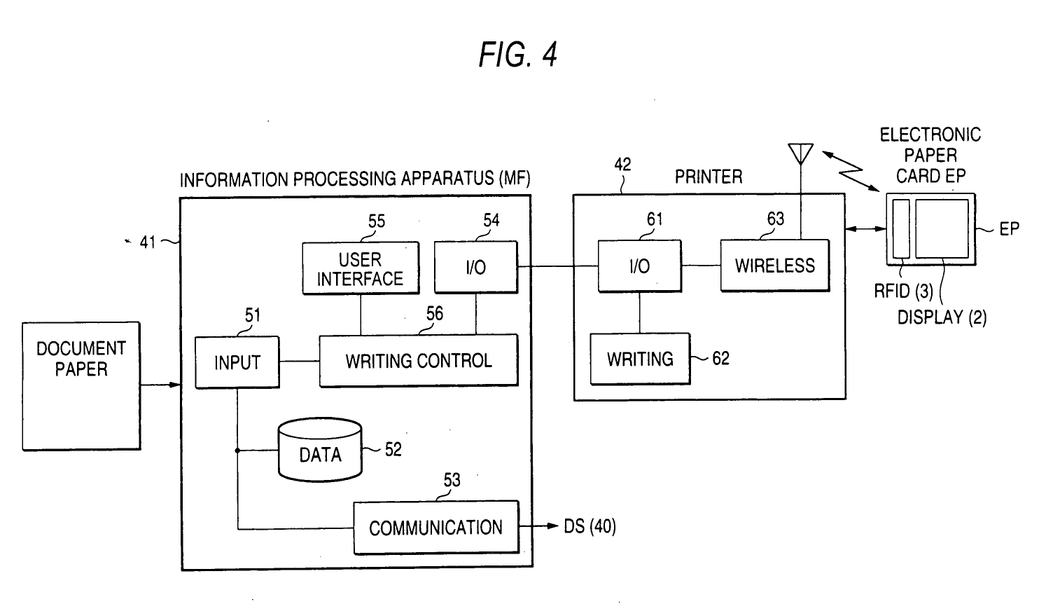

FIG. 4 shows one example of the functional configuration provided on the information processing apparatus 41 and electronic paper printer 42 for the purpose of carrying out the processing described above. The example in the figure shows the multi-function machine (MF) as the information processing apparatus 41, but the same description applies to the personal computer (PC).

Also, the information processing apparatus 41 in the example is a computer apparatus, and the functional means described hereafter are configured in such a way that the program is implemented by the relevant computer.

The information processing apparatus (MF) 41 includes input means 51 for realizing various input functions necessary for the multi-function machine, such as a scanner function and a communication function, a retaining memory 52 for processing data such as input image information, communication means 53 for carrying out communication such as sending document data read by a scanner to the document management server (DS) 40, an interface (I/O) 54 which connects with the electronic paper printer 42, user interface means 55 for providing information to the user and receiving instruction input from the user, and writing control means 56 for making the electronic paper printer 42 carry out the processing of writing of a document thumbnail image generated by the control server 43 and a document URL, as described hereafter.

The electronic paper printer 42 includes an interface (I/O) 61, which connects with the information processing apparatus 41, writing means 62 which transfers and writes an image onto the display 2 of an electronic paper card EP, and wireless means 63 which carries out wireless communication of data, such as a document URL and a card ID set in the electronic paper card, with the RFID 3 of the electronic paper card EP.

In the example the information processing apparatus 41 and the electronic paper printer 42, which are separate from each other, are connected one to the other, but the information processing apparatus 41 and the electronic paper printer 42 may also be an integrated apparatus.

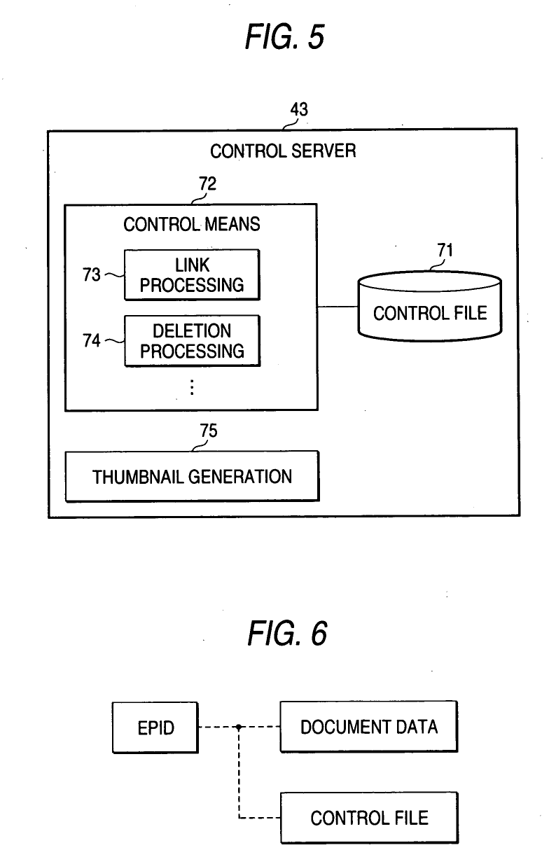

FIG. 5 shows one example of a functional configuration provided in the control server 43 for the purpose of carrying out the control processing described heretofore.

The control server 43 shown in the figure is used in the system shown in FIGS. 1 to 3.

Also, the control server 43 in the example is a computer apparatus, and the functional means 72 to 75 described hereafter are configured in such a way that the program is implemented by the relevant computer.

The control server 43 is provided with a control file memory 71, which retains the various conditions preset for the purpose of regulating control processing by the control server 43, control means 72, which carries out control of writing onto an electronic paper card EP and control of writing onto the document management server 40, in accordance with the control file conditions, and thumbnail generating means 75, which generates a thumbnail image to be written onto the electronic paper card EP.

The control means 72 includes various control functions but, as regards characteristic functions according to the invention, it includes link processing control means 73 which controls URL linking when storing document data in the document management server 40, and deletion processing control means 74 which makes an electronic paper card EP carry out deletion related processing when deleting document data from the document management server 40.

Various control functions are set in the control file 71, such as conditions determining whether or not a relevant thumbnail image can be changed when using a previously used electronic paper card EP in response to another document when storing document data, control details of an electronic paper card corresponding to the type of access (storage, deletion by removal, data readout leaving the data in the server etc.) to document data stored in the document management server 40, a frequency limit and time period limit for which document data stored in the document management server 40 can be printed out, control details of an electronic paper card when printing out document data, the possibility of accessing the document management server without using a corresponding electronic paper card EP, a setting determining whether to recall a latest version or a recording storage time version when recalling document data stored in the document management server 40, a setting which displays the fact on an electronic paper card EP that a latest version exists when document data stored in the document management server 40 is recalled, password setting information, an automatic printing (or display) setting when inserting a card, and a processing method in the event that an RFID internal memory is empty (await scanning in the case of inserting an electronic paper of which the RFID internal memory is empty into the electronic paper printer attached to an MF instrument; await data import in the case of inserting an electronic paper of which the RFID internal memory is empty into the electronic paper printer attached to a PC instrument).

The control file 71 including this kind of control condition is, as shown in FIG. 6, related to each electronic paper card EP by means of an electronic paper card ID (EPID). Furthermore, document data stored in the document management server 40 is also related, by an electronic paper card ID (EPID), to an electronic paper card EP used by inserting it into the electronic paper printer 42 when storage processing the relevant document data.

That is, with respect to an electronic paper card EP, the document data recorded and stored using the electronic paper card EP, and the control file 71, are related thereto.

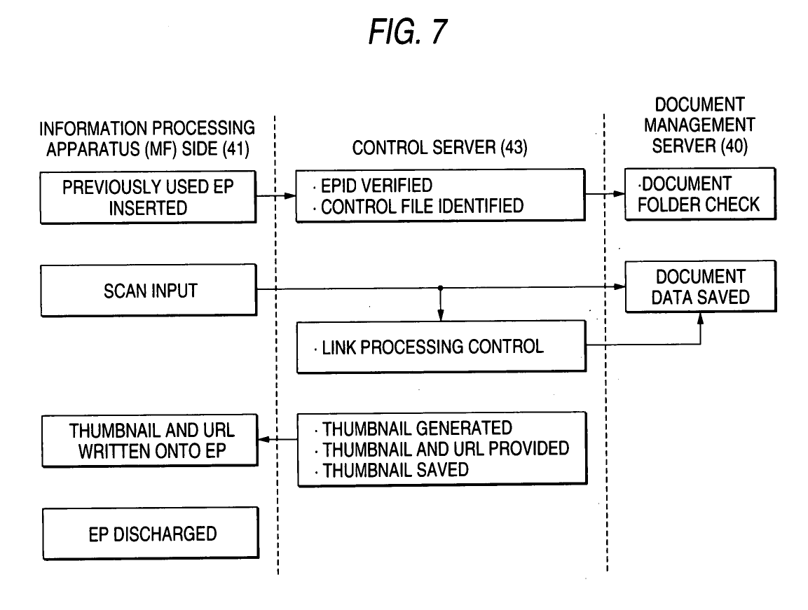

FIG. 7 shows an outline of the control processing when introducing a document paper into the system and storing it in the document management server 40.

The example shown is of storage of document data read by MF 41 scanning of a document paper, but the same applies to storage in the document management server 40 of document data from the PC 41.

In the information processing apparatus (MF) 41, a previously used electronic paper card EP related to (that is, a thumbnail image has been displayed and retained, and a document URL has been stored in the memory) document data previously stored in the control file 71 and the document management server 40, when inserted into the electronic paper printer 42, read an EPID stored in the RFID 3 from the relevant electronic paper card EP and transmit it to the control server 43.

The control server 43, when receiving an EPID, verifies the EPID and identifies the related control file 71, also, based on the relevant EPID, carrying out confirmation of a document folder in which document data related to the relevant electronic paper card EP is to be stored (i.e., in the document management server 40).

Subsequently, when receiving a scan input of document data from the input means 51, the MF 41 transmits the relevant document data to the document management server 40, at the same time providing transmission information to the control server 43.

When the control server 43 receives the transmission information, the link processing control means 73 carries out link processing control related to the scan input document data in accordance with the previously identified control file 71 setting conditions.

For example, in the event that the setting of the control file 71 is such as to merge the document data, control is carried out whereby the document data input by scanning on this occasion is merged with the document data stored in the document management server 40 by the previous processing, using the same electronic paper card EP (that is, the same URL), newly stored in the document management server 40, and the URL retained in the electronic paper EP is kept unchanged.

That is, control is carried out whereby document data is added in order to a document folder having the same URL.

Similarly, in the event that the setting of the control file 71 is such as to replace the document data, control is carried out whereby the URL assigned to the document data stored in the document management server 40 by the previous processing, using the same electronic paper card EP (that is, the same URL), is assigned to the document data input by scanning on this occasion, retained in the document management server 40, and with the URL retained in the electronic paper EP kept unchanged, the link for that URL is removed from the document data pertaining to the previous processing.

That is, control is carried out whereby a document folder having a certain URL is renewed in order by new document data.

Furthermore, the control file 71 can be set in such a way as to automatically select whether to carry out the merge control or the replacement control and implement accordingly. Alternatively, the user can be asked via the user interface 55 which control to carry out, and the control file 71 can be set to implement one of the controls in accordance with the user's instructions.

Next, as document data is stored and saved in the document management server 40, the control server 43 generates a thumbnail image to be displayed and retained in an electronic paper card EP, provides the thumbnail image (and URL, in the case that a new URL is established by a control other than those heretofore described) to the MF 41, and saves the thumbnail image as a log.

The MF 41, on receiving the thumbnail visual image and URL from the control server 43, carries out writing of the thumbnail image onto the display 2 of the electronic paper EP and of the URL onto the RFID 3, and discharges the electronic paper card EP from the electronic paper printer 43.

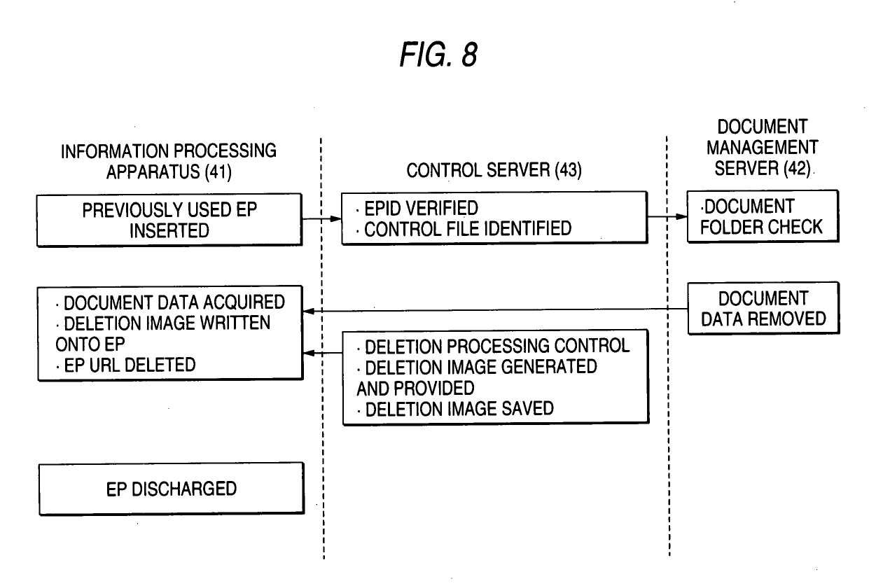

FIG. 8 shows an outline of control processing when deleting document data stored in the document management server 40.

With regard to the deletion of document data from the document management server 40, as well as direct deletion processing, the control file 71 can be set in such a way as to carry out the relevant deletion in the case of, for example, removing the document data from the document management server 40 and carrying out document printing processing by the MF 41, or removing the document data from the document management server 40 and carrying out screen display processing by the PC 41, whereby deletion processing and control processing are carried out in accordance with the relevant setting conditions. Furthermore, in the case that only some pages of the document data have been removed and printed or displayed on screen, the control file 71 can be set in such a way as to, for example, delete only that number of pages from the server 40 and reflect this deletion in a thumbnail image display of an electronic paper card EP, not delete the document data until all of it is removed, delete all the document data even in the case of partial removal, or ask the user for instruction regarding deletion and process in accordance with the instructions.

When a previously used electronic paper card EP in which a document URL is stored is inserted into the electronic paper printer 42 at the same time as a document image is displayed, the information processing apparatus 41 reads an EPID from the RFID 3 of the electronic paper card and transmits the read EPID to the control server 43. Upon reception of an EPID, as described previously, the control server 43 verifies the EPID and identifies the related control file 71, also, based on the relevant EPID, carrying out confirmation of a document folder in which document data related to the electronic paper card EP is to be stored.

Subsequently, when the information processing apparatus 41 removes (that is, reading and deletion processing) document data from the document management server 40 and carries out printing processing or screen display processing of the acquired document data, the control server 43 carries out deletion processing control in accordance with the control file 71.

For example, in a case wherein the control file 71 is set in such a way as to display a blank image as a deleted image on an electronic paper card EP, the control method 72 generates a blank image and provides the generated blank image to the information processing apparatus 41. Also, in a case wherein the control file 71 is set in such a way as to display a prescribed image, such as an advertising image, as a deleted image on an electronic paper card EP, the control method 72 provides a prescribed image preset in the control file 71 to the information processing apparatus 41. Furthermore, in a case wherein the control file 71 is set in such a way as to display, as a deletion image, a message to that effect on an electronic paper card EP, the control means 72 generates an image displayed by superimposing message lettering such as “server deletion complete” on a document thumbnail image, and provides the image to the information processing apparatus 41.

The control server 43 saves the deletion images as logs.

Upon reception of a deletion image from the control server 43, the information processing apparatus 41 causes the electronic paper printer 42 to write the deletion image onto the display 2 of an electronic paper card EP, delete a URL from the RFID 3, and discharge the electronic paper card EP.

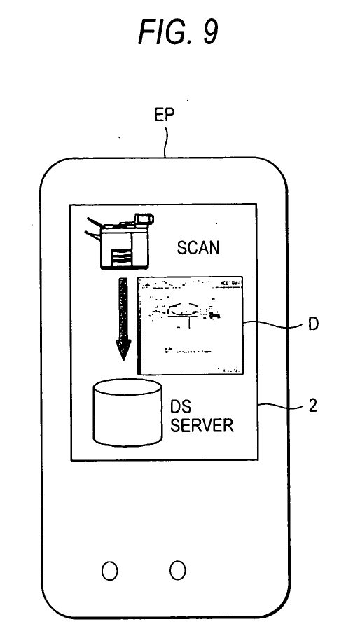

FIG. 9 shows one example of an image displayed on the display 2 of an electronic paper card EP by the storage processing described heretofore. The image is an outline, including a document thumbnail image D, showing that document data whose image has been read by the scanner of the information processing apparatus (MF) is stored in the document management server (DS) 40.

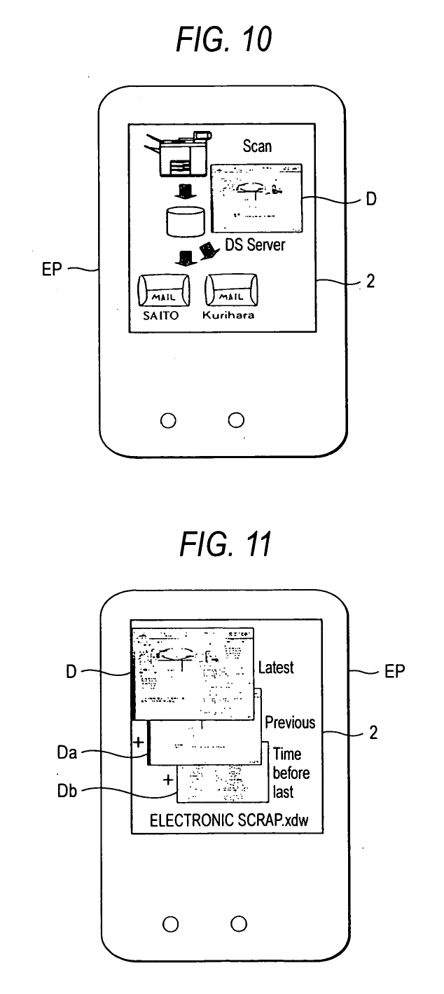

FIG. 10 shows another example of an image displayed on the display 2 of an electronic paper card EP by the storage processing described heretofore. The image is an outline, including the document thumbnail image D, showing that document data whose image has been read by the scanner of the information processing apparatus (MF) is stored in the document management server (DS) 40, on top of which the control server 43 has transmitted electronic mails, in accordance with the setting of the control file 71, notifying the users (SAITO and Kurihara) of the fact that the storage processing has been carried out.

FIG. 11 shows another example of an image displayed on the display 2 of an electronic paper card EP by the storage processing described heretofore. The image shows, including the thumbnail images D, Da and Db of the documents, that the latest document data D has been merged with the document data Da stored on the previous occasion and the document data Db stored on the occasion previous to that, and stored in the document management server (DS).

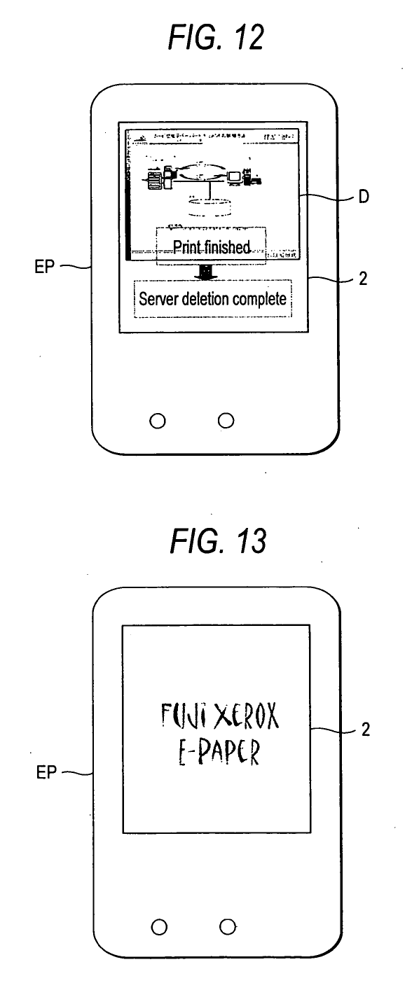

FIG. 12 shows one example of an image displayed on the display 2 of an electronic paper card EP by the deletion processing described heretofore. The image is displayed by the control server 43, including “Print finished” “Server deletion completed” messages, showing that, in accordance with the control file 71 as described heretofore, document data stored in the document management server 40 has been removed and printing processed, and the relevant document has accordingly been deleted from the document management server 40.

FIG. 13 shows another example of an image displayed on the display 2 of an electronic paper card EP by the deletion processing described heretofore. The image is displayed by the control server 43, including advertising stating “FUJI XEROX E-PAPER”, showing that, in accordance with the control file 71 as described heretofore, document data stored in the document management server 40 has been deleted from the document management server 40.

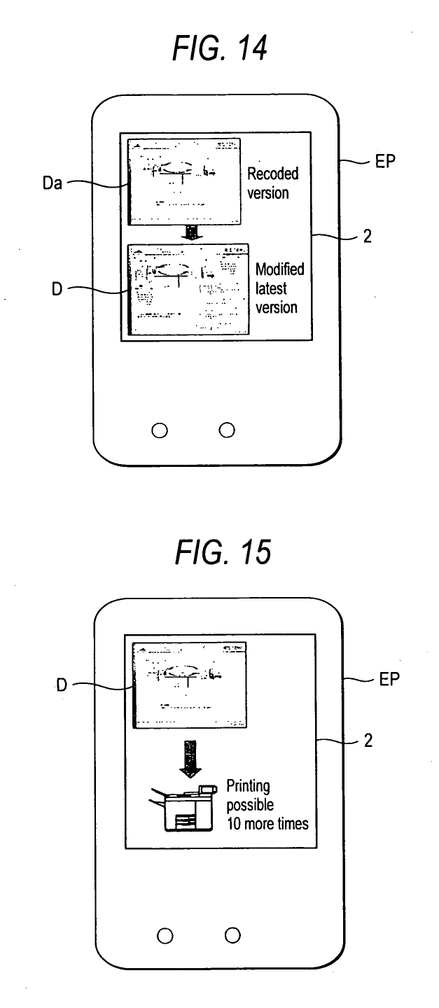

FIG. 14 shows another example of an image displayed on the display 2 of an electronic paper card EP by the storage processing described heretofore. The image shows, including the thumbnail images D and Da of the documents, that the modified latest version document data D recorded on this occasion has replaced the document data Da recorded and stored on a previous occasion. This kind of history display is carried out by the control server 43 using a thumbnail image retained as a history on the control file 71, as described heretofore.

FIG. 15 shows one example of an image displayed on the display 2 of an electronic paper card EP in a case wherein a document data printing process is conducted by a method not accompanying deletion processing. The image is displayed by the control server 43, including the thumbnail image D of the document, showing the remaining number of times the printing processed document data can be further printed, which is obtained by comparing the possible number of printings set in the control file 71 with a count value after every printing.

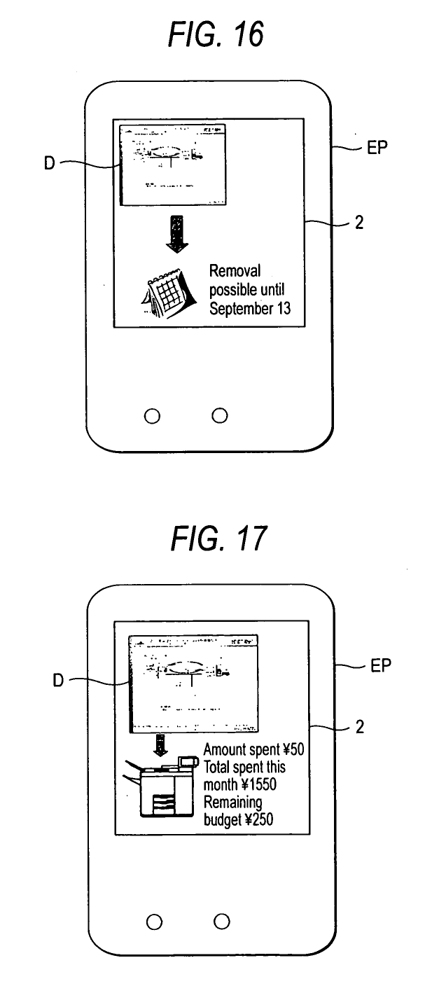

FIG. 16 shows one example of an image displayed on the display 2 of an electronic paper card EP in a case wherein document data is removed by a method not accompanying deletion processing. The image is displayed by the control server 43, including the thumbnail image D of the document, showing a possible period of use (September 13th) of the document data set in the control file 71.

FIG. 17 shows one example of an image displayed on the display 2 of an electronic paper card EP in a case wherein document data is used for perusal etc. by a method not accompanying deletion processing. The image is displayed by the control server 43, including the thumbnail image D of the document, showing information regarding an amount of money spent etc. in accordance with the accounting conditions set in the control file 71.

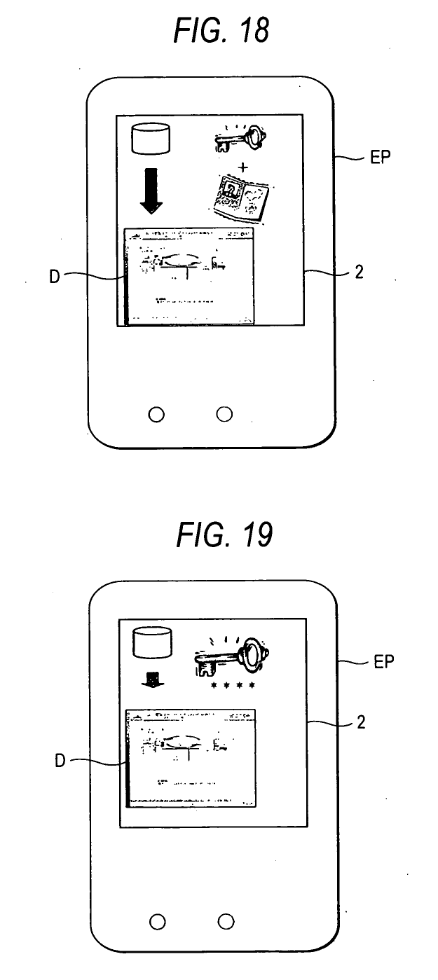

FIG. 18 shows one example of an image displayed on the display 2 of an electronic paper card EP for the purpose of displaying conditions in a case wherein document data is removed from the document management server 40 for perusal etc. The image is displayed by the control server 43, including the thumbnail image D of the document, showing the fact that, in accordance with access conditions set in the control file 71, the relevant electronic paper card EP and user ID card are necessary in order to access the document data.

FIG. 19 shows another example of an image displayed on the display 2 of an electronic paper card EP for the purpose of displaying conditions in a case wherein document data is removed from the document management server 40 for perusal etc. As in the previous example, the image shows, including the thumbnail image D of the document, that the relevant electronic paper card EP and user password are necessary in order to access the document data.

As discussed above, in an electronic paper system, using an electronic paper having a display which displays and retains an image in a no-power state and a memory (e.g., an RFID) which readably and writably stores information, link information (e.g., a URL) enabling access to document data stored in a document data storage (e.g., a document management server) is stored in the memory, and a document image (e.g., a thumbnail) according to the document data is displayed and retained on the display. The electronic paper system of an illustrative, non-limiting embodiment comprises a control apparatus (e.g., a control server) which, when storing document data in the document data storage (e.g., scan reading a document paper), in accordance with preset conditions (e.g., a control file), controls a method of storing the document data in the storage, and controls storing in the memory of link information correlating with the document data stored in response to the storage method.

More specifically, for example, the control apparatus, using link information already stored in an electronic paper used when storing document data, merges document data preexisting with respect to the link information with document data to be newly stored and stores the merged data in the document data storage as one file.

As a result, other document data can be added to the already stored document data by using an electronic paper corresponding thereto.

Also, more specifically, for example, the control apparatus, using link information stored in an electronic paper used when storing document data, releases the link between document data preexisting with respect to the link information and the link information, links document data to be newly stored to the link information from which the link has been released, and stores the linked data in the document data storage.

As a result, by using an electronic paper, document data already stored in relation thereto can be replaced with other document data.

Furthermore, the system comprises a control apparatus which, in response to accessing the document data storage (e.g., removing, copying and storing document data), in accordance with preset conditions, carries out control of changing, in response to an access mode, an image related to the document data to be accessed and which is to be displayed and retained on the electronic paper display.

More specifically, for example, the control apparatus, in response to document data being deleted from the document data storage, carries out control whereby an image related to the document data to be displayed and retained on the display is changed to an image (e.g., a message image, a blank image) indicating that the document data has been deleted. Link information retained on the electronic paper can also be deleted.

As a result, in response to the deletion of document data, information retained on the electronic paper is changed.

Also, more specifically, for example, the control apparatus, in response to document data being stored in the document data storage, carries out control whereby an image related to the document data to be displayed and retained on the electronic paper display is changed to an image indicating that the document data has been stored.

As a result, by carrying out storage control of the document data using a previously used electronic paper, an image displayed and retained on the electronic paper display is changed to an image related to the newly stored document. Also, by making the replacement image one which shows that storage processing has taken place, the display will be easier for the user to understand.

Furthermore, the invention can be actualized as the aforementioned kind of electronic paper system, and can also be actualized as a control apparatus which configures the electronic paper system, a program whereby a computer configures the control apparatus, and a method implemented by the electronic paper system.

The entire disclosure of Japanese Patent Application No 2005-265498 filed on Sep. 13, 2005 including specification, claims, drawings and abstract is incorporated herein by reference in its entirety.

1. An electronic paper system comprising:
a document data storage which stores document data;
an electronic paper having a display that displays and retains a document image based on the document data in a no-power state and a memory that readably and writably stores link information enabling access to the document data stored in the document data storage; and
a control apparatus which, when storing the document data in the document data storage, controls a method of storing the document data in the document data storage in accordance with a preset condition, and controls the storage of the link information in the memory of the electronic paper in response to the method thus controlled.

2. An electronic paper system according to claim 1, wherein
the control apparatus uses the link information stored in the memory of electronic paper to control a method of storing a new, second document data in the document data storage.

3. An electronic paper system according to claim 2, wherein
the control apparatus merges the first document data stored in the document data storage with the new, second document data, and stores the merged data in the document data storage.

4. An electronic paper system according to claim 2, wherein
the control apparatus disables the access to the first document data by the link information, and stores the new, second document data in the document data storage to be accessible by the same link information.

5. An electronic paper system comprising:
a document data storage which stores document data;
an electronic paper having a display that displays and retains a document image based on the document data in a no-power state and a memory that readably and writably stores link information enabling access to the document data stored in the document data storage; and
a control apparatus which, in response to access to the document data storage, controls the display of the electronic paper to change the document image of the document data in accordance with a preset condition.

6. An electronic paper system according to claim 5, wherein
the control apparatus, in response to deletion of the document data from the document data storage, controls the display of the electronic paper to change the document image of the document data to an image indicative of the deletion of the document data.

7. An electronic paper system according to claim 5, wherein
the control apparatus, in response to storage of the document data in the document data storage, controls the display of the electronic paper to change the document image of the document data to an image indicative of the storage of the document data.

8. A control apparatus for an electronic paper system including a document data storage which stores document data, and an electronic paper having a display that displays and retains a document image based on the document data in a no-power state and a memory that readably and writably stores link information enabling access to the document data stored in the document data storage, the control apparatus comprising:
means for controlling a method of storing the document data in the document data storage in accordance with a present condition when the document data is stored in the document data storage; and
means for controlling the storage of the link information in the memory of the electronic paper in response to the method thus controlled.

9. A control apparatus for an electronic paper system including a document data storage which stores document data, and an electronic paper having a display that displays and retains a document image based on the document data in a no-power state and a memory that readably and writably stores link information enabling access to the document data stored in the document data storage, the control apparatus comprising:
means for obtaining a preset condition; and
means, in response to access to the document data storage, for controlling the display of the electronic paper to change the document image fo the document data in accordance with the present condition.

10. A storage medium readable by a computer, the storage medium storing a program of instructions executable by the computer to perform a function for controlling an electronic paper system including a document data storage which stores document data, and an electronic paper having a display that displays and retains a document image based on the document data in a no-power state and a memory that readably and writably stores link information enabling access to the document data stored in the document data storage, the function comprising the steps of:
controlling a method of storing the document data in the document data storage in accordance with a present condition when the document data is stored in the document data storage; and
controlling the storage of the link information in the memory of the electronic paper in response to the method thus controlled.

11. A storage medium readable by a computer, the storage medium storing a program of instructions executable by the computer to perform a function for controlling an electronic paper system including a document data storage which stores document data, and an electronic paper having a display that displays and retains a document image based on the document data in a no-power state and a memory that readably and writably stores link information enabling access to the document data stored in the document data storage, the function comprising the steps of:
obtaining a preset condition; and
controlling the display of the electronic paper to change the document image of the document data in accordance with the present condition, in response to access to the document data storage.

12. A control method for an electronic paper system including: a document data storage which stores document data; an electronic paper having a display that displays and retains a document image based on the document data in a no-power state and a memory that readably and writably stores link information enabling access to the document data stored in the document data storage; and a control apparatus, the control method comprising the steps of:
controlling, with the control apparatus, a method of storing the document data in the document data storage in accordance with a present condition when the document data is stored in the document data storage; and
controlling, with the control apparatus, the storage of the link information in the memory of the electronic paper in response to the method thus controlled.

13. A control method for an electronic paper system including: a document data storage which stores document data; an electronic paper having a display that displays and retains a document image based on the document data in a no-power state and a memory that readably and writably stores link information enabling access to the document data stored in the document data storage; and a control apparatus, the control method comprising the steps of:
obtaining a preset condition with the control apparatus; and
controlling, with the control apparatus, the display of the electronic paper to change the document image of the document data in accordance with the present condition, in response to access to the document data storage.
